(19) United States
(12) Patent Application Publication
(10) Pub. No.: US 2009/0094052 A1
(43) Pub. Date: Apr. 9, 2009

(54) SYSTEM AND METHOD FOR DYNAMICALLY GENERATED CLINICAL FORM ELEMENTS

(75) Inventors: Alan James, Salt Lake City, UT (US); Kelly Utrup, Hoffman Estates, IL (US); Pradeep Shankar, Palatine, IL (US); Pen Xu, Hoffman Estates, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/867,506

(22) Filed: Oct. 4, 2007

(51) Int. Cl. G06Q 50/00

(52) U.S. Cl. 705/2

(57) ABSTRACT

Certain embodiments of the present invention provide a system and method for the dynamic creation of a clinical form. The method comprises acquiring a list of available clinical elements models. In an embodiment, a set of parameters is acquired for each clinical element model. A visual representation associated with each clinical element model based on the set of parameters is acquired. The behavior rules based on the visual representation associated with the clinical element models is acquired. The set of behavior rules is associated with the visual representation of the clinical element models to create a set of clinical form elements. One or more clinical form elements may be added to a form. Such a system and method may allow a user to dynamically create clinical forms.

### BACKGROUND OF THE INVENTION

The present invention generally relates to a system and method for generating a computer user interface to be used by healthcare professionals. Particularly, the present invention relates to dynamically generating clinical form elements and an associated user interface.

The use of computers in the healthcare industry is widespread. Computers may be used by healthcare professionals for many applications in the healthcare industry. For example, computers may be used for patient data entry, order medications, assessments, triage notes, or other types of information.

Currently, healthcare professionals utilize many different electronic forms to enter patient information. The electronic forms are generally developed by software engineers at the time of product development. A user may then utilize the forms that the software engineer has made available. If a user desires a configuration of a form other than what the software developer has made available, it generally requires on-site customization. The on-site customization may include some type of customizable form where the user interface representations of clinical elements, sometimes referred to as form elements or clinical form elements, may be added and arranged on a screen to create a custom form. However, the on-site customization generally only has the ability to work with the form elements that were created by the software developers. The creation of new form elements by software developers may be a time consuming process.

Accordingly, a system and method is needed that allows the dynamic creation of clinical forms. Such a system and method may allow a user to automatically create custom clinical forms applicable to the application of the user.

### SUMMARY OF THE INVENTION

Certain embodiments of the present invention include a method for generating a clinical form. The method includes acquiring a list of available clinical element models and acquiring a set of parameters for each clinical element model. The method also includes acquiring a visual representation associated with each clinical element model based on the set of parameters. The method also includes acquiring a set of behavioral rules associated with the available clinical element models. The method may also include associating the set of behavior rules associated with the available clinical element models with the visual representation associated with the available clinical element models to form a set of clinical form elements. The method may also include adding a clinical form element to a form. The step of acquiring a set of parameters may include acquiring a set of parameters for each available clinical element model. The parameters may include information associated with the application context of for the available clinical element models. The parameters may include information to identify the visual requirements of the available clinical element models. The set of behavior rules may be acquired based on the visual representation associated with the available clinical element models. The set of behavior rules may be acquired for each clinical element model.

Certain embodiments of the present invention include a system for creating a clinical form element. The system may include a clinical element models unit having computer software for identifying the available clinical element models. The system may also include a clinical dictionary unit having computer software for acquiring a set of parameters for the available clinical element models. The system may also include a clinical mapping unit having computer software for acquiring a visual representation associated with the available clinical element models based on the set of parameters. The system may also include a clinical form elements unit having computer software for acquiring a set of behavioral rules for the available clinical element models and creating one or more clinical form elements. In an embodiment, the system may include a form unit for creating a form from one or more clinical form elements. The form may be a medical form. The system may also include a display unit for displaying the form. The clinical form elements unit may acquires a set of behavior rules based on the visual representation associated with the available clinical models. The clinical form elements unit associates each set of behavior rules with an available clinical element model. The system may also include a data base unit. In an embodiment, the a set of parameters, the visual representation, and the set of behavior rules are acquired from the data base unit.

Certain embodiments of the present invention may include a computer readable medium including a set of instructions for execution by a computer. The set of instructions may include a first acquisition routine for acquiring a list of available clinical elements models. The set of instructions may include a second acquisition routine for acquiring a set of parameters for the available clinical element models. The set of instructions may also include a third acquisition routine for acquiring a visual representation associated with the available clinical element models based on the set of parameters. The set of instructions may also include a fourth acquisition routine for acquiring a set of behavioral rules associated with the available clinical element models. The set of instructions may also include an association routine for associating the set of behavior rules with the visual representation of the clinical element models to create a set of clinical form elements. The set of instructions may also include an addition routine for adding one or more clinical form elements to a form. The fourth acquisition routine may acquire a set of behavior rules based on the visual representation associated with the available clinical models.

### BRIEF DESCRIPTION OF THE DRAWINGS

FIG. 1 illustrates a system that may be used in accordance with an embodiment of the present invention.

FIG. 2 illustrates a system that may be used in accordance with an embodiment of the present invention.

FIG. 3 illustrates method that may be used in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

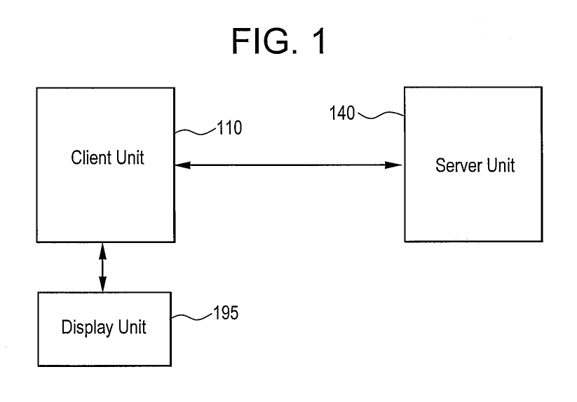

Certain embodiments of the present invention have the technical effect of allowing the dynamic creation of clinical forms. FIG. 1 illustrates a system 100 that may be used for healthcare applications in accordance with an embodiment of the present invention. The system 100 illustrates a client unit 110. The client unit may be a computer unit, such as a personal computer. The client unit 110 may receive input from a user, for example through a keyboard or computer mouse. Other forms of input may be received, for example voice commands. The client unit may include hardware, firmware, and software. The system 110 may also include a display unit 195. The display unit 195 may be a general computer display unit. The client 110 may be connected to the display unit 195 to display various graphics to a user. The display unit 195 may be a single display unit or multiple display units. Additionally, the display unit 195 may be a two-dimensional display unit or a three-dimensional display unit, for example. Accordingly, any display unit may be used in accordance with the present invention.

The client 110 may also be connected to a server unit 140. The server unit 140 may include hardware, software, firmware, and memory. The client unit 110 may communicate with the server unit 140. The connection between the client unit 110 and the server unit 140 may be wired or wireless. The client unit 110 represents, in general, equipment and software. The actual physical devices of the client unit 110 may be separate units, part of a single unit, a computer system, or part of a computer system. The server unit 140 represents, in general, equipment and software. The actual physical devices of the server unit 140 may be separate units, part of a single unit, a computer system, or part of a computer system. The client unit 110 and server unit 140 may be connected to other devices via an electronic network. The components of the system 100 may be single units, separate units, may be integrated in various forms, and may be implemented in hardware, firmware, and/or in software.

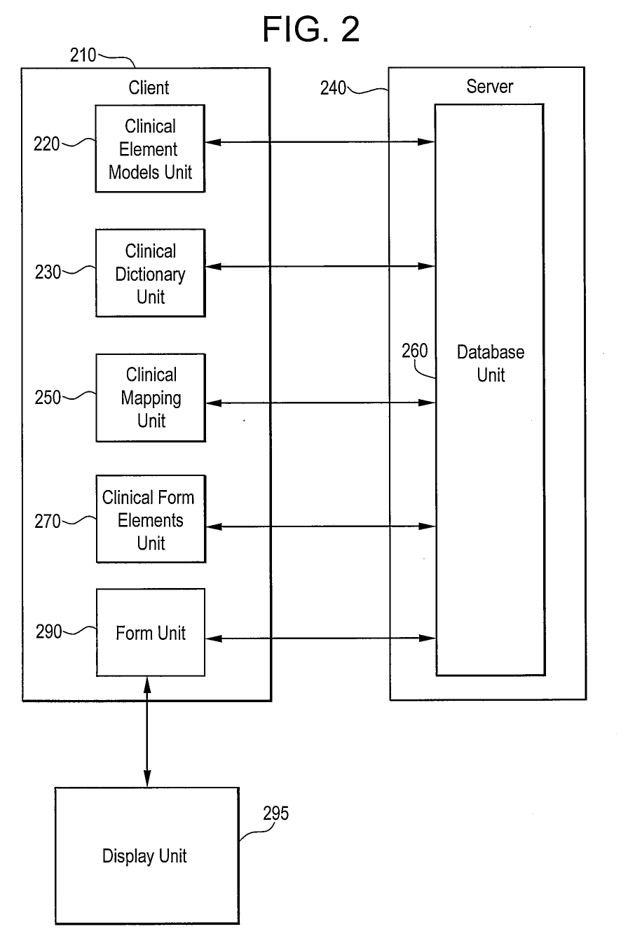

FIG. 2 illustrates a system 200 illustrating a conceptual flow diagram in accordance with an embodiment of the present invention. The system 200 includes a client unit 210 and a server unit 240. The client unit 210 and server unit 240 are in communication as in the system 100. In an embodiment, the client unit 210 contains hardware, firmware, and/or software to implement the clinical element models unit 220, the clinical dictionary unit 230, the clinical mapping unit 250, the clinical form elements unit 270, and the form unit 290. In an embodiment, the server unit 240 contains hardware, firmware, and/or software to implement the database unit 260. The system 200 also includes a display unit 295 that is in communication with the client unit 210. It is contemplated that hardware, firmware, and/or software to implement the clinical element models unit 220, the clinical dictionary unit 230, the clinical form elements unit 270, the form unit 290, the clinical mapping unit 250, and the database unit 260, may be implemented in the client 210 or the server 240.

In an embodiment, a user desiring to create a medical form having various inputs and parameters for a specific application may launch computer software on the client 210 to create the form. When the user launches computer software to create the form, the computer software initiates the clinical element models unit 220. The clinical element models unit 220 contains a list of available clinical element models. A clinical element model is a set of qualifiers that identify the visual representation of the clinical element and an application context. For example, a clinical element model may include a text qualifier indicating that the clinical element model should include a text label. In another example, the clinical element model may include a Boolean qualifier indicating that the clinical element model should include radio buttons with yes and no choices. Any qualifiers describing visual representation of the clinical element model may be used. The application context of the clinical element model indicates in what context the clinical element model may be used. In continuing with the example provided above, a clinical element model having a text qualifier may also have a particular application context to help determine what the text should state.

Once the clinical element models unit 220 identifies the available clinical element models, the clinical dictionary unit 230 acquires a set of parameters for each clinical element model. For example, the set of parameters may more fully describe the visual parameters required to satisfy the qualifiers and application context associated with each clinical element model. For example, the clinical dictionary unit 230 may utilize the qualifiers and application context information for each clinical element model to acquire a set of parameters that identify the visual requirements necessary to satisfy the qualifiers and application context. For example, the clinical dictionary unit 230 may receive a qualifier that a clinical element model includes a text qualifier and the clinical dictionary unit 230 may acquire a set of parameters indicating the size of the text box.

Once the clinical dictionary unit 230 acquires a set of parameters for each clinical element model, the clinical dictionary unit 230 may communicate the information to the clinical mapping unit 250. The clinical mapping unit 250 receives the set of parameters for each clinical element model and obtains the details of the visual display information from the data base unit 260. For example, the clinical mapping unit 250 may utilize the parameters, qualifiers, and application context to look-up text that should be inserted in a text box. Another example is looking up the text that should be inserted in a drop-down menu, or the color of a particular application. This information is acquired from the database unit 260 and sent back to the client unit 210. The client unit 210 directs this information to the clinical form elements unit 270.

The clinical form elements unit 270 utilizes the visual information acquired by the clinical mapping unit 250 to acquire behavioral information for the clinical element models. In an embodiment, the clinical form elements unit 270 queries the server unit 240 for a set of behavior rules for the clinical form elements. In an embodiment, the clinical form elements unit 270 queries the server unit 240 for a set of behavior rules for all the clinical form elements that have been created by the clinical form elements unit 240. Alternatively, the clinical form elements unit 270 queries the server unit 240 for a set of behavior rules for the clinical form elements that have been selected by a user.

Once the server unit 240 receives the query from the clinical form elements unit 270, the server unit 240 utilizes the parameters of the clinical element models used to create the clinical form elements to acquire a set of behavior rules for the clinical form elements from the database unit 260. The set of rules direct the functionality of the clinical form element. For example, the set of rules may instruct the clinical form elements to enable or disable fields based on input to other fields within the clinical form element. Since the behavior may change according to application context, the set of rules may adjust the functionality of the clinical form element according to the identified application context. In an embodiment, the set of rules may be modified to support varying execution contexts.

In an embodiment, the server unit 240 then associates the set of behavior rules with the visual representation of the clinical element models. Alternatively, the client unit 210 associates the set of behavior rules with the visual representation of the clinical element models. In an embodiment, the clinical form elements unit 270 associates each set of behavior rules with a clinical element model such that the visual representation of each clinical element model is associated with some type of behavior. In an embodiment, the behavior may be an action, such as links for selections on a drop down menu, or the behavior may be no action, such as text.

Once the set of behavior rules and the visual representation have been acquired, one or more of the clinical form elements may be used to create a form by the form unit 290. For example, the form may be a medical form. In an embodiment, a user may select one or more clinical form elements to create the form. The form may be displayed on the display unit 295.

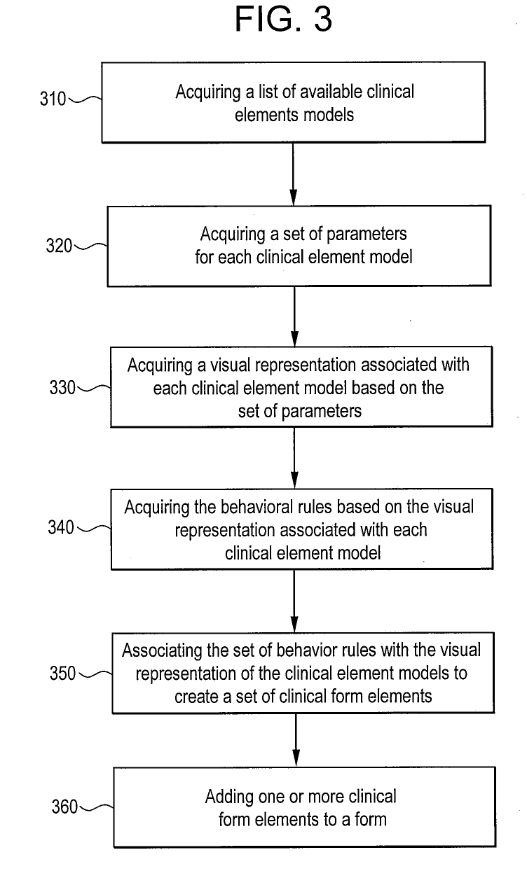

FIG. 3 illustrates a method 300 in accordance with an embodiment of the present invention. At step 310, a list of available clinical elements models is acquired. As discussed above, a clinical element model is a set of qualifiers that identify the visual representation of the clinical element and an application context. For example, a clinical element model may include a text qualifier indicating that the clinical element model should include a text label. In another example, the clinical element model may include a Boolean qualifier indicating that the clinical element model should include radio buttons with yes and no choices. Any qualifiers describing visual representation of the clinical element model may be used. The application context of the clinical element model indicates in what context the clinical element model may be used. In continuing with the example provided above, a clinical element model having a text qualifier may also have a particular application context to help determine what the text should state.

At step 320, a set of parameters for each clinical element model is acquired. For example, the set of parameters may more fully describe the visual parameters required to satisfy the qualifiers and application context associated with each clinical element model. For example, the qualifiers and application context information for each clinical element model may be used to acquire a set of parameters that identify the visual requirements necessary to satisfy the qualifiers and application context.

At step 330, a visual representation that is associated with each clinical element model that is based on the set of parameters may be acquired. The visual representation may be visual display information. For example, the parameters, qualifiers, and application context of the clinical element module may be used to look-up text that should be inserted in a text box. Another example is looking up the text that should be inserted in a drop-down menu, or the color of a particular application.

At step 340, the behavioral rules associated with the clinical element models are acquired. In an embodiment, the behavior rules are based on the visual representation associated with each clinical element model. The parameters of the clinical element models may be used to acquire a set of behavior rules for the clinical form elements. The set of rules direct the functionality of the clinical form elements. For example, the set of rules may instruct the clinical form elements to enable or disable fields based on input to other fields within the clinical form element. Since the behavior may change according to application context, the set of rules may adjust the functionality of the clinical form element according to the identified application context. In an embodiment, the set of rules may be modified to support varying execution contexts.

At step 350, the set of behavior rules is associated with the visual representation of the clinical element models to create a set of clinical form elements. In an embodiment, the clinical form element is created by associating the visual representation of each clinical element model with the behavior rules for each clinical element model. At step 360, one or more of the clinical form elements from the set of clinical form elements may be added to a form. In such a manner, the form, and thus user interface, is customizable for the desired application of the user.

The system and method described above may be carried out as part of a computer-readable storage medium including a set of instructions for a computer. The set of instructions may include a first acquisition routine for acquiring a list of available clinical elements models. The set of instructions may also include a second acquisition routine for acquiring a set of parameters for each clinical element model. The set of instructions may also include a third acquisition routine for acquiring a visual representation associated with each clinical element model based on the set of parameters. The set of instructions may also include a fourth acquisition routine for acquiring the behavior rules based on the visual representation associated with each clinical element. The set of instructions may also include an association routine for associating the set of behavior rules with the visual representation of the clinical element models to create a set of clinical form elements. The set of instructions may also include an addition routine for adding one or more clinical form elements to a form.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for generating a clinical form, said method comprising:
acquiring a list of available clinical elements models;
acquiring a set of parameters for said available clinical element models;
acquiring a visual representation associated with said available clinical element models based on said set of parameters; and, acquiring a set of behavioral rules associated with said available clinical element models.

2. The method of claim 1 further comprising, associating said set of behavior rules associated with said available clinical element models with said visual representation associated with said available clinical element models to form a set of clinical form elements.

3. The method of claim 2, further comprising adding a clinical form element to a form.

4. The method of claim 1, wherein said step of acquiring a set of parameters includes acquiring a set of parameters for each available clinical element model.

5. The method of claim 1, wherein said parameters include information associated with the application context of for said available clinical element models.

6. The method of claim 1, wherein said parameters include information to identify the visual requirements of said available clinical element models.

7. The method of claim 1, wherein said set of behavior rules is acquired based on said visual representation associated with said available clinical element models.

8. The method of claim 1, wherein a set of behavior rules is acquired for each clinical element model.

9. A system for creating a clinical form element, said system comprising:
a clinical element models unit having computer software for identifying the available clinical element models;
a clinical dictionary unit having computer software for acquiring a set of parameters for said available clinical element models;
a clinical mapping unit having computer software for acquiring a visual representation associated with said available clinical element models based on said set of parameters; and, a clinical form elements unit having computer software for acquiring a set of behavioral rules for said available clinical element models and creating one or more clinical form elements.

10. The system of claim 9, further comprising a form unit for creating a form from one or more clinical form elements.

11. The system of claim 10, wherein said form is a medical form.

12. The system of claim 10, further comprising a display unit for displaying said form.

13. The system of claim 9, wherein said clinical form elements unit acquires a set of behavior rules based on said visual representation associated with said available clinical models.

14. The system of claim 9, wherein the clinical form elements unit associates each set of behavior rules with an available clinical element model.

15. The system of claim 9, further comprising a data base unit.

16. The system of claim 15, wherein said set of parameters, said visual representation, and said set of behavior rules are acquired from said data base unit.

17. A computer readable medium including a set of instructions for execution by a computer, said set of instructions comprising:
a first acquisition routine for acquiring a list of available clinical elements models;
a second acquisition routine for acquiring a set of parameters for said available clinical element models;
a third acquisition routine for acquiring a visual representation associated with said available clinical element models based on said set of parameters; and, a fourth acquisition routine for acquiring a set of behavioral rules associated with said available clinical element models.

18. The set of instructions of claim 17, further including an association routine for associating the set of behavior rules with the visual representation of the clinical element models to create a set of clinical form elements.

19. The set of instructions of claim 18, further including an addition routine for adding one or more clinical form elements to a form.

20. The set of instructions of claim 17, wherein said fourth acquisition routine acquires a set of behavior rules based on said visual representation associated with said available clinical models.
